(19) United States
(12) Patent Application Publication
(10) Pub. No.: US 2019/0034182 A1
(43) Pub. Date: Jan. 31, 2019

(54) ELECTRONIC APPARATUS AND NON-TRANSITORY COMPUTER READABLE RECORDING MEDIUM

(71) Applicant: KYOCERA Document Solutions Inc., Osaka (JP)

(72) Inventor: Takeshi HAMAKAWA, Osaka (JP)

(21) Appl. No.: 16/033,422

(22) Filed: Jul. 12, 2018

(30) Foreign Application Priority Data
Jul. 26, 2017 (JP) 2017-144476

(51) Int. Cl. G06F 8/65; G06F 9/451

(52) U.S. Cl. CPC G06F 8/65; G06F 9/453

(57) ABSTRACT

The controller executes a parameter change program to operate as a firmware updating unit that records a firmware updating method of the electronic apparatus, and updates the firmware, and a setup wizard program executing unit that sets an initial parameter after updating the firmware. If the firmware updating unit records interactive updating as the firmware updating method, the all-automatic setting flag is off, and the individual automatic setting flag is off, the setup wizard program executing unit manually sets the initial parameter of the setup data including the individual automatic setting flag off.

### INCORPORATION BY REFERENCE

This application claims the benefit of Japanese Priority Patent Application JP 2017-144476 filed Jul. 26, 2017, the entire contents of which are incorporated herein by reference.

### FIELD

The present disclosure relates to an electronic apparatus that sets an initial parameter when updating firmware. The present disclosure further relates to a non-transitory computer readable recording medium that records a parameter change program.

### BACKGROUND

There is known a technique of updating firmware of an electronic apparatus, for example, an image forming apparatus (MFP, Multifunction Peripheral).

### SUMMARY

When updating firmware of an electronic apparatus, for example, an image forming apparatus (MFP, Multifunction Peripheral), it is desirable to set an initial parameter appropriately.

According to an embodiment of the present disclosure, there is provided an electronic apparatus, including: a communication device; an operation device; a display device; a nonvolatile storage medium that stores a new firmware image when updating firmware of the electronic apparatus; and a controller, in which the controller executes a parameter change program to operate as a firmware updating unit that records a firmware updating method of the electronic apparatus, and updates the firmware, and a setup wizard program executing unit that sets an initial parameter after updating the firmware, the firmware image includes at least one control program code that is used to execute various setting, a setup wizard program code that is executed by the setup wizard program executing unit, and setup wizard data that is used by the setup wizard program executing unit to set the initial parameter after updating the firmware, the setup wizard data includes one setup data header, and N-number (N is an integer of 0 or more) of setup data, the setup data header includes a setup data number that indicates the number of unprocessed setup data, and an all-automatic setting flag, each of the N-number of setup data includes a screen number uniquely identifying a screen that is used to set a parameter, the at least one control program code including the screen, a data list that lists values as candidates of the initial parameter, and an individual automatic setting flag, and if the firmware updating unit records interactive updating as the firmware updating method, the all-automatic setting flag is off, and the individual automatic setting flag is off, the setup wizard program executing unit manually sets the initial parameter of the setup data including the individual automatic setting flag off.

According to an embodiment of the present disclosure, there is provided a non-transitory computer readable recording medium that records a parameter change program, in which the parameter change program causes an electronic apparatus to operate as a firmware updating unit that records a firmware updating method of the electronic apparatus, and updates the firmware, and a setup wizard program executing unit that sets an initial parameter after updating the firmware, the firmware image that is used to update the firmware includes at least one control program code that is used to execute various setting, a setup wizard program code that is executed by the setup wizard program executing unit, and setup wizard data that is used by the setup wizard program executing unit to set the initial parameter after updating the firmware, the setup wizard data includes one setup data header, and N-number (N is an integer of 0 or more) of setup data, the setup data header includes a setup data number that indicates the number of unprocessed setup data, and an all-automatic setting flag, each of the N-number of setup data includes a screen number uniquely identifying a screen that is used to set a parameter, the at least one control program code including the screen, a data list that lists values as candidates of the initial parameter, and an individual automatic setting flag, and if the firmware updating unit records interactive updating as the firmware updating method, the all-automatic setting flag is off, and the individual automatic setting flag is off, the setup wizard program executing unit manually sets the initial parameter of the setup data including the individual automatic setting flag off.

These and other objects, features and advantages of the present disclosure will become more apparent in light of the following detailed description of best mode embodiments thereof, as illustrated in the accompanying drawings.

### BRIEF DESCRIPTION OF FIGURES

FIG. 1 schematically shows the configuration of the image forming apparatus 20;

FIG. 2 shows functional blocks of the controller circuit 21;

FIG. 3 shows an example of the structure of the firmware image FI;

FIG. 4 shows an example of a structure of the setup wizard data D1;

FIG. 5 shows a specific example of the automatic setting and the manual setting;

FIG. 6 shows a main processing flow of the initial value setting executed by the image forming apparatus 20;

FIG. 7 shows a processing flow of the all-automatic setting (Step S9);

FIG. 8 shows a processing flow of the individual setting (Step S11); and

FIG. 9 shows a processing flow of starting or resuming the setup by selecting an icon.

### DETAILED DESCRIPTION

Hereinafter, an embodiment of the present disclosure will be described with reference to the drawings. Note that, in the following description, an image forming apparatus will be employed as an example of an electronic apparatus that updates firmware and sets initial parameters.

### 1. CONFIGURATION OF IMAGE FORMING APPARATUS

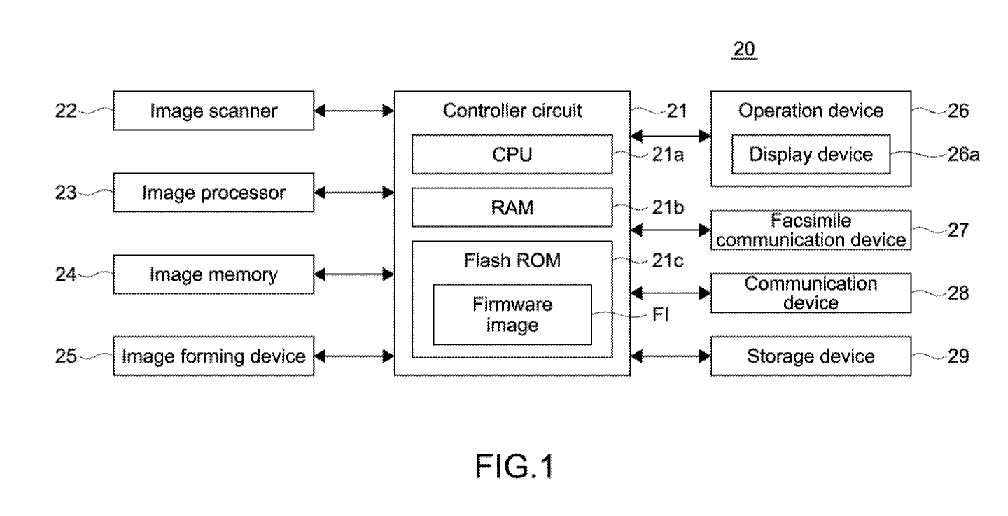

Firstly, a configuration of an image forming apparatus according to an embodiment of the present disclosure will be described. FIG. 1 schematically shows the configuration of the image forming apparatus 20.

The image forming apparatus 20 includes a controller circuit 21. The controller circuit 21 includes a CPU (Central Processing Unit) 21a, a RAM (Random Access Memory) 21b, a flash ROM (Flash Read Only Memory) 21c (nonvolatile storage medium), dedicated hardware circuits, and the like and performs overall operational control of the image forming apparatus 20. The flash ROM 21c stores the firmware image FI.

The controller circuit 21 is connected to an image scanner 22, an image processor 23, an image memory 24, an image forming device 25, an operation device 26, a display device 26a, a facsimile communication device 27, a communication device 28, a storage device 29, and the like. The controller circuit 21 performs operational control of the respective devices connected thereto and sends/receives signals and data to/from those devices.

According to job execution instructions input by a user via the operation device 26 or a PC connected to the network, the controller circuit 21 controls drive and process of mechanisms requisite for executing operational control of functions such as a scanner function, a printing function, a copy function, and a facsimile sending/receiving function.

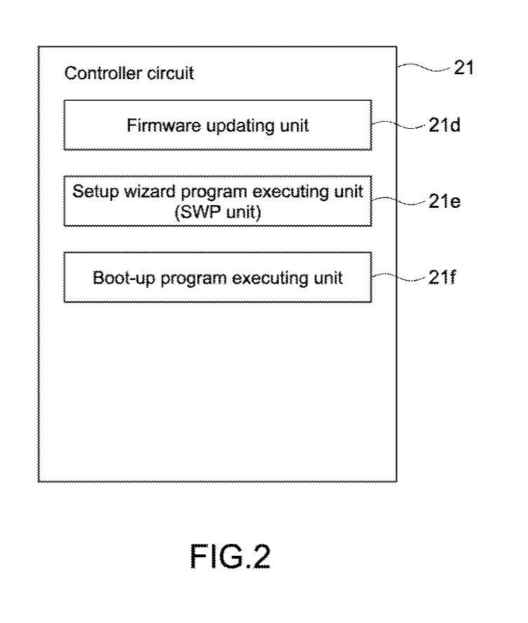

Further, as shown in FIG. 2, the controller circuit 21 includes the firmware updating unit 21d, the setup wizard program executing unit 21e, and the boot-up program executing unit 21f. The CPU of the image forming apparatus 20 loads programs, which are stored in a ROM or the like, in a RAM and executes the programs. When the CPU of the image forming apparatus 20 executes the programs, the CPU operates as the firmware updating unit 21d, the setup wizard program executing unit 21e, and the boot-up program executing unit 21f, which are functional blocks.

The firmware updating unit 21d records a firmware updating method (remote updating or interactive updating) of the image forming apparatus 20, and updates the firmware. Note that the remote updating means updating without a person in front of the image forming apparatus 20. The interactive updating means updating through interaction between the image forming apparatus 20 and a person in front of the image forming apparatus 20.

The setup wizard program executing unit 21e sets an initial parameter after updating the firmware. The initial setting is executed by using the setup wizard data D1 (described later). Details will be described later. Note that hereinafter the setup wizard program executing unit 21e may be abbreviated to the SWP unit 21e.

The boot-up program executing unit 21f boots up the image forming apparatus 20.

The image scanner 22 reads an image from a script.

The image processor 23 carries out an image process as necessary on image data of an image read by the image scanner 22. For example, the image processor 23 corrects shading of an image read by the image scanner 22 and carries out other image process to improve the quality of the image to be formed.

The image memory 24 includes an area that temporarily stores data of a script image read by the image scanner 22 or data to be printed by the image forming device 25.

The image forming device 25 forms an image of image data and the like read by the image scanner 22.

The operation device 26 includes a touch panel device and an operation key device that accept user's instructions on various operations and processes executable by the image forming apparatus 20. The touch panel device includes the display device 26a such as an LCD (Liquid Crystal Display) equipped with a touch panel.

The facsimile communication device 27 includes an encoding/decoding device, a modulation/demodulation device, and an NCU (Network Control Unit) (all of which are not shown) and transmits facsimiles using a public telephone network.

The communication device 28 is constituted of a communication module such as a LAN board and sends/receives various types of data to/from an apparatus (PC, etc.) connected to a network via a LAN connected to the communication device 28, and the like.

The storage device 29 stores a script image read by the image scanner 22 and the like. The storage device 29 is a large-volume storage device such as an HDD (Hard Disk Drive).

The configuration of the image forming apparatus 20 has been described above.

### 2. STRUCTURE OF FIRMWARE IMAGE

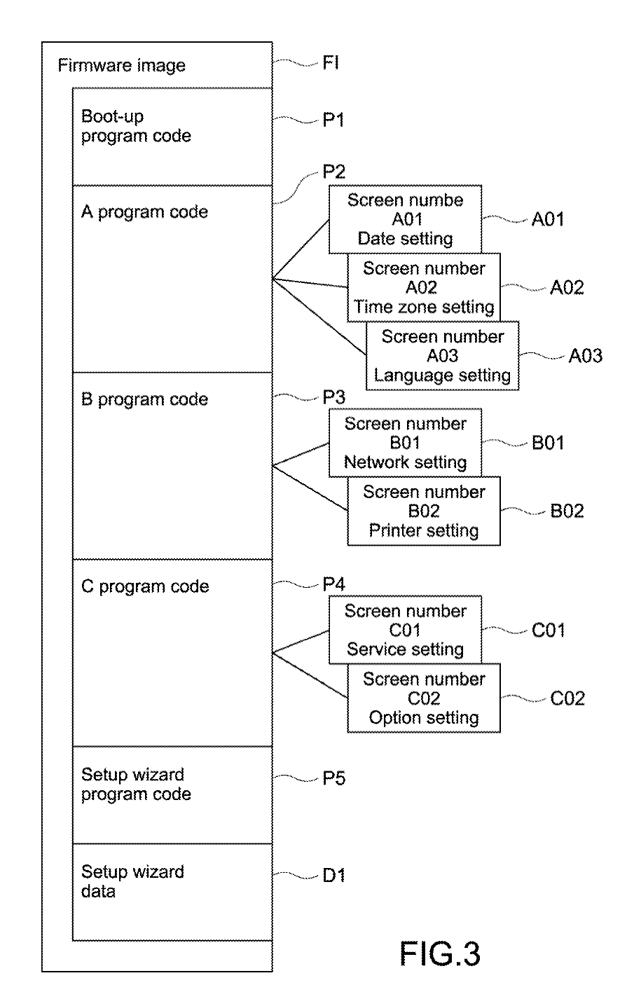

Next, the structure of the aforementioned firmware image FI will be described. FIG. 3 shows an example of the structure of the firmware image FI.

In the example of FIG. 3, the firmware image FI includes the boot-up program code P1, the A program code P2, the B program code P3, the C program code P4, the setup wizard program code P5, and the setup wizard data D1.

The boot-up program code P1 is a program code that is used to boot up the image forming apparatus 20 after restarting the image forming apparatus 20. The boot-up program executing unit 21f executes the boot-up program code P1.

The A program code P2, the B program code P3, and the C program code P4 are control program codes that are used to execute various setting. Each of the program codes P2, P3, and P4 includes screens that are used to execute individual setting. When executing each of the program codes P2, P3, and P4, the screens included in each of the program codes P2, P3, and P4 are displayed to a user. A user uses the displayed screens and executes various setting.

Note that each screen is managed by using a screen number that uniquely identifies each screen. For example, with regard to the A program code P2, the screen number A01 indicates a screen that is used to execute date setting. The screen number A02 indicates a screen that is used to execute time zone setting. The screen number A03 indicates a screen that is used to execute language setting.

Note that FIG. 3 shows three program codes as control program codes that are used to execute various setting. Three is merely an example. Any number of control program code(s) may be provided.

The setup wizard program code P5 is a program image, and the SWP unit 21e executes the setup wizard program code P5.

The SWP unit 21e uses the setup wizard data D1 when setting an initial parameter after updating the firmware. The setup wizard data D1 is written if it is necessary to set an initial parameter after updating the firmware. Details will be described later.

According to an embodiment of the present disclosure, in the firmware of the image forming apparatus 20, the flash ROM 21c stores, separately, the setup wizard program code P5 that is used to set an initial parameter, and the setup wizard data D1 that is used when executing the setup wizard program code P5. According to this structure, it is possible to flexibly change the setup wizard data D1 compared to a structure in which data is embedded in a program code.

In the firmware images of the same version supplied by a manufacturer or a dealer, the boot-up program code P1 to the setup wizard program code P5 are common to all the firmware images. It is possible to provide the firmware images including different setup wizard data D1 depending on customers.

The structure of the firmware image FI has been described above.

### 3. STRUCTURE OF SETUP WIZARD DATA

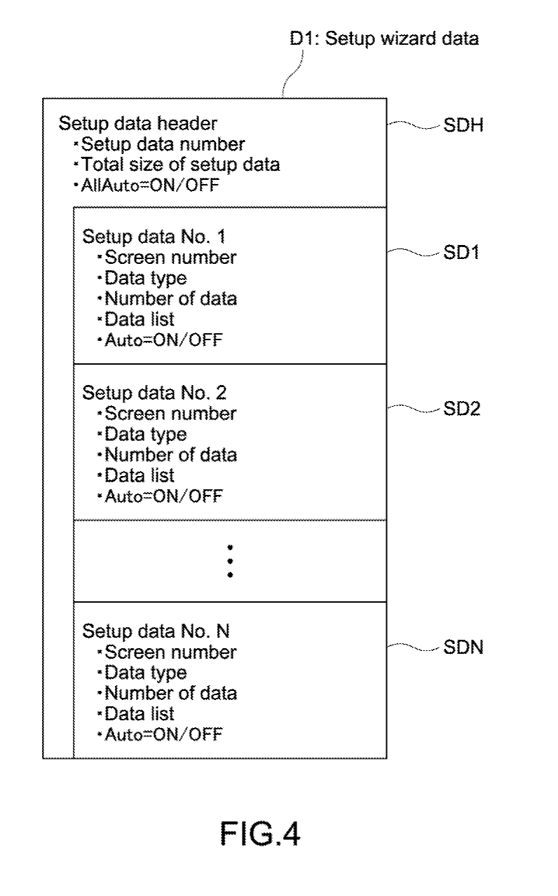

Next, a structure of the setup wizard data D1 will be described. FIG. 4 shows an example of a structure of the setup wizard data D1.

As shown in FIG. 4, the setup wizard data D1 includes the setup data header SDH and the N-number (N is an integer of 0 or more) of setup data SD1 to SDN. Each of the setup data SD1 to SDN is used to execute initial setting of an individual item such as date and time zone.

The setup data header SDH includes three items. The first item is a setup data number. The setup data number indicates the number of the setup data SD1 to SDN, to which the initial setting is unprocessed, included in the setup wizard data D1.

The second item is a total size of the setup data. The total size of the setup data indicates the total size of the setup data SD1 to SDN, to which the initial setting is unprocessed.

The third item is the AllAuto flag (all-automatic setting flag). The AllAuto flag has an ON or OFF value. If AllAuto=ON, all-automatic setting is executed for all the setup data SD1 to SDN irrespective of the automatic setting or the manual setting, which is individually set. If AllAuto=OFF, initial values are set on a basis of the automatic setting or the manual setting, which is individually set for each of the setup data SD1 to SDN. Details will be described later.

The setup data SDN includes five items. The first item is a screen number. The SWP unit 21e uses the screen number, for example, calls the screen A01 included in the A program code P2, and uses the screen A01 for the initial setting.

The second item is a data type. This item indicates a data type of values, which are candidates of an initial parameter and included in a data list (described later). For example, the data type is one of text, integer, decimal number, hexadecimal number, and the like.

The third item is the number of data. This item indicates the number of values as candidates of an initial parameter included on the data list.

The fourth item is the data list. This item is a list of values as candidates (available items) of the actual initial parameter. With regard to the automatic setting, the first value on the data list is set as the initial parameter. With regard to the manual setting, a user selects an initial parameter from the values on the data list.

The fifth item is the Auto flag (individual automatic setting flag). The Auto flag has an ON or OFF value. The Auto flag is effective if the firmware is updated interactively and AllAuto=OFF is specified. If Auto=ON, the automatic setting is executed only for the setup data SDN, to which Auto=ON is specified. If Auto=OFF, the manual setting is executed only for the setup data SDN, to which Auto=OFF is specified. Details will be described later.

The structure of the setup wizard data D1 has been described above.

### 4. AUTOMATIC SETTING AND MANUAL SETTING

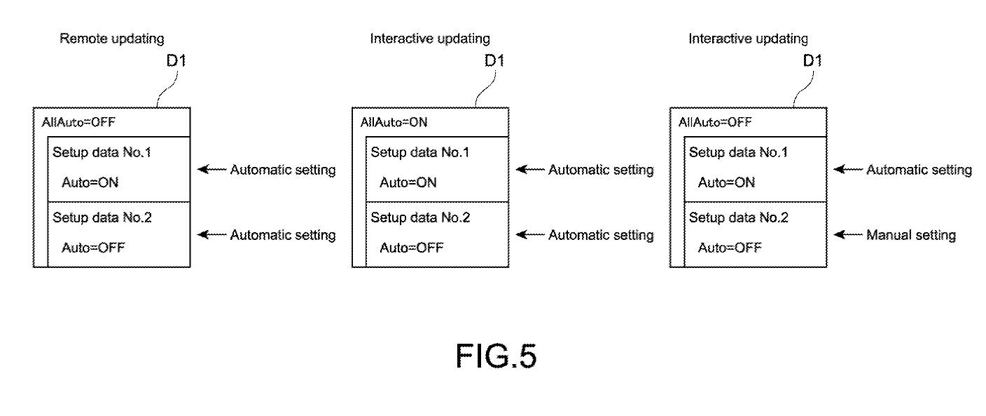

Next, how the automatic setting is selected and how the manual setting is selected for the initial value setting using the setup data SDN will be described in detail. FIG. 5 shows a specific example of the automatic setting and the manual setting.

In FIG. 5, the left part shows a case where the firmware is updated remotely. If the firmware is updated remotely, it is assumed that no service person or user (nobody) is in front of the image forming apparatus 20, in which the firmware is updated. Therefore, even if the automatic setting is specified with the AllAuto flag or the Auto flag in the setup wizard data D1, the all-automatic setting is executed.

In FIG. 5, the center part shows a case where the firmware is updated interactively, and the AllAuto flag is ON. Even if Auto=OFF is specified in the individual setup data SDN, all the setting is executed automatically.

In FIG. 5, the right part shows a case where the firmware is updated interactively, and the AllAuto flag is OFF. If Auto=OFF is specified in the individual setup data SDN, the manual setting is used to set an initial value. In this case, a service person or a user is capable of setting an initial value by using the operation device 26.

How the automatic setting is selected and how the manual setting is selected have been described above.

### 5. MAIN PROCESSING FLOW

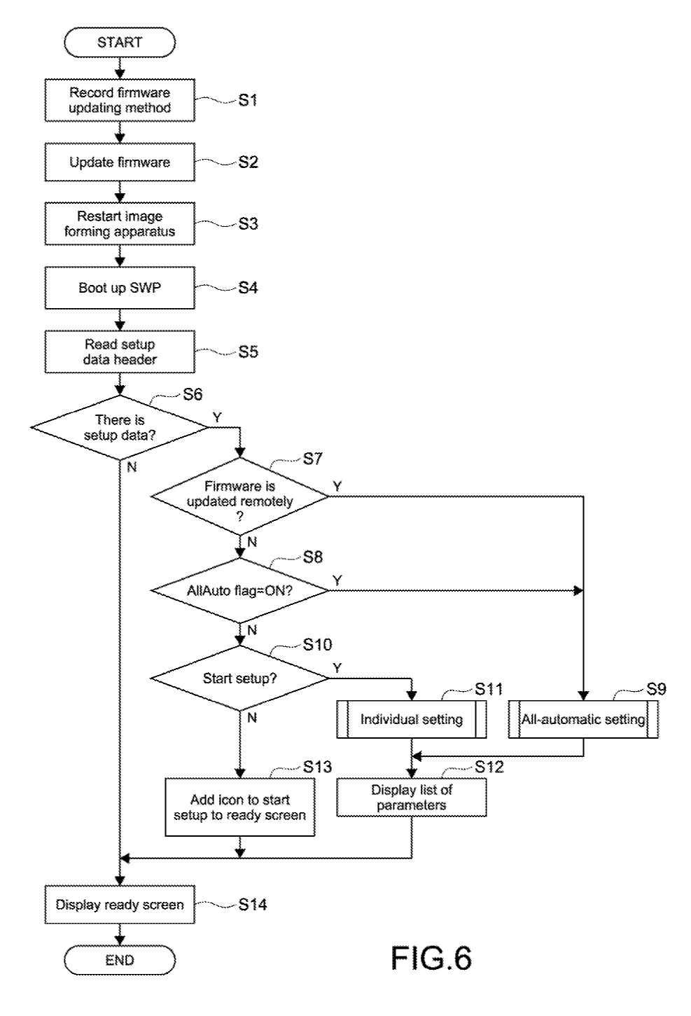

Next, a main processing flow of the initial value setting of the image forming apparatus 20 will be described. FIG. 6 shows a main processing flow of the initial value setting executed by the image forming apparatus 20.

Firstly, the firmware updating unit 21d records the firmware updating method (the remote updating or the interactive updating) (Step S1).

Next, the firmware updating unit 21d updates the firmware (Step S2).

Next, the firmware updating unit 21d restarts the image forming apparatus 20 (Step S3).

Next, the boot-up program executing unit 21f boots up the SWP unit 21e (Step S4).

Next, the SWP unit 21e reads the setup data header SDH (Step S5).

Next, the SWP unit 21e refers to the setup data number of the setup data header SDH, and determines whether or not there is setup data SDN (Step S6).

If there is no setup data SDN (Step S6, N), it means that there is no item to set an initial value. Therefore a ready screen is displayed (Step S14), and the process is finished. Note that the ready screen is a screen that is displayed in the status where the functions (copy, print, and the like) of the image forming apparatus 20 are available (ready status).

If there is setup data SDN (Step S6, Y), the SWP unit 21e determines whether or not the firmware is updated remotely (Step S7).

If the firmware is updated remotely (Step S7, Y), the SWP unit 21e executes the all-automatic setting (described later, Step S9), and displays the list of the initial parameters (Step S12). After that, the SWP unit 21e displays the ready screen (Step S14), and finishes the process.

If the firmware is updated not remotely (Step S7, N), the SWP unit 21e determines whether or not the AllAuto flag is ON (Step S8).

If the AllAuto flag is ON (Step S8, Y), the SWP unit 21e executes the all-automatic setting (described later, Step S9), and displays the list of the initial parameters (Step S12). After that, the SWP unit 21e displays the ready screen (Step S14), and finishes the process.

If the AllAuto flag is OFF (Step S8, N), the SWP unit 21e asks a user whether or not to start setup (Step S10).

If the setup is not to be started (Step S10, N), the SWP unit 21e adds an icon to start the setup to the ready screen (Step S13), displays the ready screen (Step S14), and finishes the process.

If the setup is to be started (Step S10, Y), the SWP unit 21e executes the individual setting (described later, Step S11), displays the list of the initial parameters (Step S12), then displays the ready screen (Step S14), and finishes the process.

The main processing flow about the initial value setting executed by the image forming apparatus 20 has been described above.

### 6. PROCESSING FLOW OF ALL-AUTOMATIC SETTING (STEP S9)

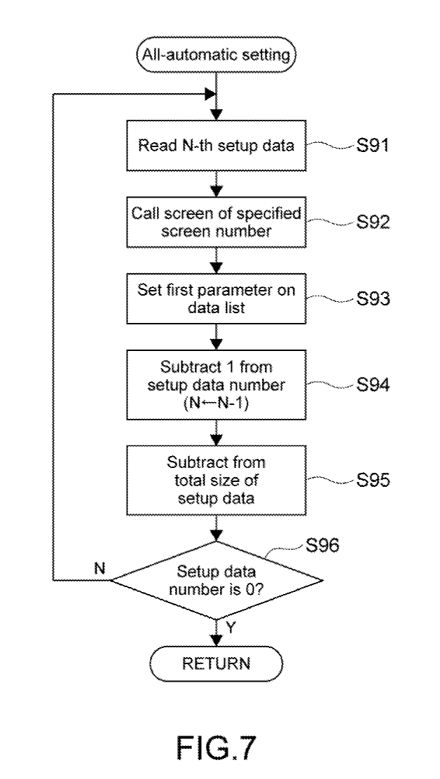

Next, the processing flow of the all-automatic setting (Step S9) will be described. FIG. 7 shows a processing flow of the all-automatic setting (Step S9).

Firstly, the SWP unit 21e reads the N-th (largest) setup data SDN out of the first to N-th setup data SDN (Step S91).

Next, the SWP unit 21e calls the screen of the screen number specified in the read setup data SDN (Step S92).

Next, the SWP unit 21e sets, as the initial parameter, the initial (first) value on the data list in the read setup data SDN (Step S93).

Next, the SWP unit 21e subtracts 1 from the setup data number (N) (Step S94).

Next, the SWP unit 21e subtracts the size of the setup data SDN from the total size of the setup data (Step S95).

Next, the SWP unit 21e determines whether or not the setup data number is 0 (Step S96).

If the setup data number is not 0 (Step S96, N), it means that there is unprocessed setup data SDN. Therefore the SWP unit 21e returns to Step S91 and repeats the process.

If the setup data number is 0 (Step S96, Y), it means that the setting of initial parameters has been completed for all the setup data SDN. Therefore the SWP unit 21e returns back to the main routine process.

The processing flow of the all-automatic setting (Step S9) has been described above. Note that, during execution of the all-automatic setting process, a screen indicating that “all-automatic setting is being processed” or the like may be displayed on the display device 26a of the image forming apparatus 20.

### 7. PROCESSING FLOW OF INDIVIDUAL SETTING (STEP S11)

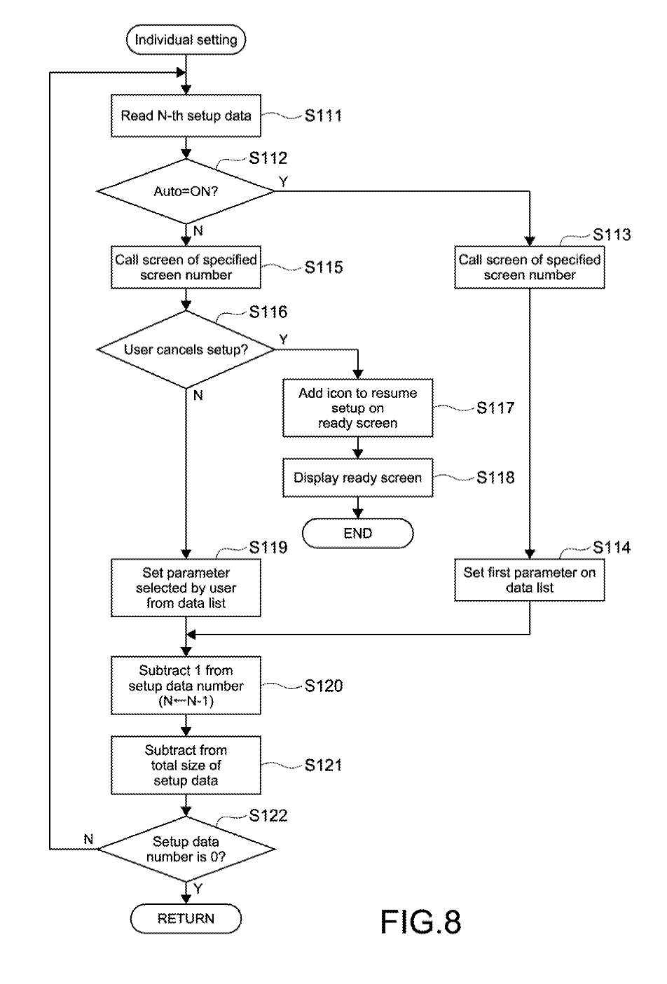

Next, a processing flow of the individual setting (Step S11) will be described. FIG. 8 shows a processing flow of the individual setting (Step S11).

Firstly, the SWP unit 21e reads the N-th (largest) setup data SDN out of the first to N-th setup data SDN (Step S111).

Next, the SWP unit 21e determines whether or not the Auto flag of the read setup data SDN is ON (Step S112).

If the Auto flag is ON (Step S112, Y), the SWP unit 21e calls the screen of the screen number specified in the read setup data SDN (Step S113).

Next, the SWP unit 21e sets, as the initial parameter, the initial (first) value on the data list in the read setup data SDN (Step S114). Note that, during execution of the automatic setting process, a screen indicating that “automatic setting is being processed” or the like may be displayed on the display device 26a of the image forming apparatus 20.

Next, the SWP unit 21e subtracts 1 from the setup data number (N) (Step S120).

Next, the SWP unit 21e subtracts the size of the setup data SDN from the total size of the setup data (Step S121).

If the Auto flag is OFF (Step S112, N), the SWP unit 21e calls the screen of the screen number specified in the read setup data SDN (Step S115).

Next, the SWP unit 21e determines whether or not a user cancels the setup on the way (Step S116).

If a user cancels the setup on the way (Step S116, Y), the SWP unit 21e adds an icon to resume the setup on the ready screen (Step S117), displays the ready screen (Step S118), and the finishes process.

If a user does not cancel the setup on the way (Step S116, N), the SWP unit 21e receives a parameter selected by a user from the data list, and sets the received parameter as the initial parameter (Step S119).

Next, the SWP unit 21e subtracts 1 from the setup data number (N) (Step S120).

Next, the SWP unit 21e subtracts the size of the setup data SDN from the total size of the setup data (Step S121).

Next, the SWP unit 21e determines whether or not the setup data number is 0 (Step S122).

If the setup data number is not 0 (Step S122, N), it means that there is unprocessed setup data SDN. Therefore the SWP unit 21e returns to Step S91 and repeats the process.

If the setup data number is 0 (Step S122, Y), it means that the setting of initial parameters has been completed for all the setup data SDN. Therefore the SWP unit 21e returns back to the main routine process.

The processing flow of the individual setting (Step S11) has been described above.

### 8. PROCESSING FLOW OF STARTING OR RESUMING SETUP BY SELECTING ICON

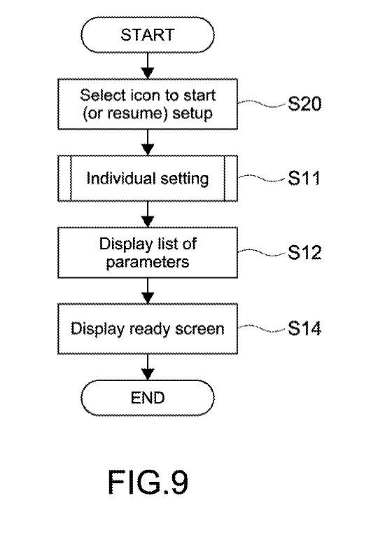

Next, a processing flow of starting or resuming the setup by selecting an icon will be described. FIG. 9 shows a processing flow of starting or resuming the setup by selecting an icon.

Firstly, a user selects the icon to start the setup or the icon to resume the setup on the ready screen to execute (Step S20).

Next, the SWP unit 21e executes the individual setting (Step S11).

Next, the SWP unit 21e displays the list of initial parameters (Step S12), then displays the ready screen (Step S14), and finishes the process.

The processing flow of starting or resuming the setup by selecting an icon has been described above.

### 9. CONCLUSION

When updating firmware of an electronic apparatus, for example, an image forming apparatus (MFP, Multifunction Peripheral), it is desirable to appropriately set an initial parameter.

In view of the aforementioned circumstances, for example, according to a conceivable technique, when remotely updating firmware of an image forming apparatus, the firmware to be updated and a script (initial value setting program) are sent together to the image forming apparatus. In order to customize an initial parameter, the script for setting an initial value is executed before and after updating.

Further, for example, according to another conceivable technique, when updating firmware of an image forming apparatus, information of an initial parameter, which has changed because a new function is added or the specification is changed, is provided to a user.

Further, for example, according to another conceivable technique, an initial parameter is automatically set after updating firmware of an image forming apparatus.

However, according to those conceivable techniques, an initial parameter is automatically set after updating firmware. As a result, an initial parameter set in the automatic setting may not always be an initial parameter that a user wants to set.

To the contrary, according to the present embodiment, there is provided the electronic apparatus 20 operates as the firmware updating unit 21d that records a firmware updating method of the electronic apparatus 20, and updates the firmware, and the setup wizard program executing unit 21e that sets an initial parameter after updating the firmware. The firmware image includes at least one control program code that is used to execute various setting, a setup wizard program code that is executed by the setup wizard program executing unit 21e, and setup wizard data D1 that is used by the setup wizard program executing unit 21e to set the initial parameter after updating the firmware. The setup wizard data D1 includes one setup data header SDH, and N-number (N is an integer of 0 or more) of setup data SDN. The setup data header SDH includes a setup data number that indicates the number of unprocessed setup data SDN, and an all-automatic setting flag. Each of the N-number of setup data SDN includes a screen number uniquely identifying a screen that is used to set a parameter, the at least one control program code including the screen, a data list that lists values as candidates of the initial parameter, and an individual automatic setting flag. If the firmware updating unit 21d records interactive updating as the firmware updating method, the all-automatic setting flag is off, and the individual automatic setting flag is off, the setup wizard program executing unit 21e manually sets the initial parameter of the setup data SDN including the individual automatic setting flag off.

As a result, when setting an initial parameter after updating firmware, it is possible to select the automatic setting and the manual setting easily.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus, comprising:
a communication device;
an operation device;
a display device;
a nonvolatile storage medium that stores a new firmware image when updating firmware of the electronic apparatus; and
a controller, wherein
the controller executes a parameter change program to operate as
a firmware updating unit that records a firmware updating method of the electronic apparatus, and updates the firmware, and
a setup wizard program executing unit that sets an initial parameter after updating the firmware,
the firmware image includes
at least one control program code that is used to execute various setting,
a setup wizard program code that is executed by the setup wizard program executing unit, and
setup wizard data that is used by the setup wizard program executing unit to set the initial parameter after updating the firmware,
the setup wizard data includes
one setup data header, and
N-number (N is an integer of 0 or more) of setup data,
the setup data header includes
a setup data number that indicates the number of unprocessed setup data, and
an all-automatic setting flag,
each of the N-number of setup data includes
a screen number uniquely identifying a screen that is used to set a parameter, the at least one control program code including the screen,
a data list that lists values as candidates of the initial parameter, and
an individual automatic setting flag, and
if the firmware updating unit records interactive updating as the firmware updating method, the all-automatic setting flag is off, and the individual automatic setting flag is off, the setup wizard program executing unit manually sets the initial parameter of the setup data including the individual automatic setting flag off.

2. The electronic apparatus according to claim 1, wherein
if the firmware updating unit records remote updating as the firmware updating method, the setup wizard program executing unit automatically sets the initial parameters of all the setup data.

3. The electronic apparatus according to claim 1, wherein
if the firmware updating unit records interactive updating as the firmware updating method, and the all-automatic setting flag is on, the setup wizard program executing unit automatically sets the initial parameters of all the setup data.

4. The electronic apparatus according to claim 1, wherein
when the setup wizard program executing unit sets the initial parameter by using each of the N-number of setup data, the setup wizard program executing unit repeats the steps of
setting N-th setup data, then
subtracting 1 from the setup data number, and
if (N−1) is not 0, setting (N−1)-th setup data.

5. The electronic apparatus according to claim 1, wherein
when the setup wizard program executing unit sets the initial parameter about each of the N-number of setup data, the setup wizard program executing unit calls the screen included in the at least one control program code on a basis of the screen number included in the N-number of setup data.

6. The electronic apparatus according to claim 1, wherein
after the setup wizard program executing unit completes setting of the initial parameter about each of the N-number of setup data, the setup wizard program executing unit displays a list of the set initial parameter on the display device.

7. A non-transitory computer readable recording medium that records a parameter change program, wherein
the parameter change program causes an electronic apparatus to operate as
a firmware updating unit that records a firmware updating method of the electronic apparatus, and updates the firmware, and
a setup wizard program executing unit that sets an initial parameter after updating the firmware,
the firmware image that is used to update the firmware includes
at least one control program code that is used to execute various setting,
a setup wizard program code that is executed by the setup wizard program executing unit, and
setup wizard data that is used by the setup wizard program executing unit to set the initial parameter after updating the firmware,
the setup wizard data includes
one setup data header, and
N-number (N is an integer of 0 or more) of setup data,
the setup data header includes
a setup data number that indicates the number of unprocessed setup data, and
an all-automatic setting flag,
each of the N-number of setup data includes
a screen number uniquely identifying a screen that is used to set a parameter, the at least one control program code including the screen,
a data list that lists values as candidates of the initial parameter, and
an individual automatic setting flag, and
if the firmware updating unit records interactive updating as the firmware updating method, the all-automatic setting flag is off, and the individual automatic setting flag is off, the setup wizard program executing unit manually sets the initial parameter of the setup data including the individual automatic setting flag off.
